(19) United States
(12) Patent Application Publication
(10) Pub. No.: US 2008/0238322 A1
(43) Pub. Date: Oct. 2, 2008

(54) Structural unit for an electric lamp with an outer bulb

(75) Inventors: Sascha Piltz, Berlin (DE); Karen Twesten, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 12/078,381

(22) Filed: Mar. 31, 2008

(30) Foreign Application Priority Data
Mar. 30, 2007 (DE) 10 2007 015 480.3

(51) Int. Cl. H01J 61/30

(52) U.S. Cl. 313/634

(57) ABSTRACT

The structural unit for an electric lamp, with an elongated, ceramic inner bulb, with a central part, is closed at two sides by capillaries, the inner bulb having a lamp axis, and a luminous means being accommodated in the inner bulb, the inner bulb being surrounded by an outer bulb, and the outer bulb having two ends, which are joined directly to the capillaries of the discharge vessel via in each case one joining means.

### TECHNICAL FIELD

The invention is based on a structural unit for an electric lamp with an outer bulb in accordance with the precharacterizing clause of claim 1. Such lamps are in particular high-pressure discharge lamps or halogen incandescent lamps.

### PRIOR ART

WO-A 2006/0131202 describes a high-pressure discharge lamp with an outer bulb, in which an outer bulb is joined to a bottom plate, which is used for passing through the power supply lines. The glass bulb is in this case formed using hard glass technology and aluminosilicate glass. As a result, pinch sealing the outer bulb is not required and the length of the outer bulb is reduced.

EP-A 1 659 617 has disclosed equipping a high-pressure discharge lamp with an outer bulb which has a shortened pinch seal. In this case, a cavity is left free between the two foils in the pinching face, which cavity contains the power supply line and part of the discharge vessel.

EP-A 1 492 146 has disclosed a manufacturing method for an electric lamp with an outer bulb, in which the outer bulb incompletely surrounds the inner vessel. A variant with an outer bulb which completely surrounds the inner vessel is specified, for example, in EP-A 465 083. This document attempts to configure an outer bulb in the case of a discharge vessel consisting of quartz glass in such a way that known exhaust tube techniques can be radically dispensed with.

DE-Az 10 2006 045 889.3 has disclosed a manufacturing method for a high-pressure discharge lamp in which a ceramic discharge vessel is arranged in a shortened outer bulb consisting of quartz glass by means of foil fuse-sealing.

### DESCRIPTION OF THE INVENTION

The object of the present invention is to provide a structural unit for an electric lamp whose physical length is markedly reduced in comparison with conventional lamps, so that the construction of particularly more compact light sources is made possible.

A further object is the reduction of component parts and quicker manufacture as a result of the avoidance of lengthy processes. A further object is the provision of a lamp which can be manufactured in a simple and cost-effective manner.

This object is achieved by the characterizing features of claim 1.

Particularly advantageous configurations are given in the dependent claims.

The structural unit can either be fitted directly with a suitable base fitting or alternatively, and preferably, it can be inserted into a reflector lamp or luminaire.

A reduction in the axial length of an outer bulb is generally desirable for the purpose of miniaturizing electric lamps; this applies in particular to high-pressure discharge lamps such as metal-halide lamps. This aim is particularly important in the case of reflector lamps. In order to integrate high-pressure discharge lamps with ceramic discharge vessels as the light source in reflector lamps, the total length of the high-pressure discharge lamp needs to be reduced. This is necessary, for example, in order to maintain the standard lengths of the reflector lamps or in order to use smaller reflectors or in order to vary the light center and in order to have more space available for fitting and fixing elements.

The invention brings about a reduction in the outer bulb length in such a way that frame components or external power supply lines are positioned outside the outer bulb because the latter does not cover the entire length of the discharge vessel, with the result that the outer bulb only takes on the function of a thermal insulator or of protecting the discharge vessel.

The outer bulb, which is preferably embodied in quartz glass, surrounds the ceramic discharge vessel of the high-pressure discharge lamp only insofar as it provides a defined environment. The particular feature lies in the fact that the thermally shaped outer bulb terminates at the level of the capillaries of the discharge vessel or of a metallic or nonmetallic, but electrically conductive connection piece, which is fitted directly at the end of the capillary, and forms a common sealing face with the capillaries or the connection piece. This sealing face can be produced directly between the glass material of the outer bulb and the capillary ceramic or the connection piece or indirectly by means of a joining glass solder.

The outer bulb filling can optionally be a vacuum, nitrogen (50 mbar-800 mbar), argon (50 mbar-800 mbar) or air (atmospheric pressure, open system). The filling of the discharge vessel can take place before or after the joint is produced.

The shortening of the outer bulb reduces the overall length of the lamp, which can also only be in the form of a structural unit, with the result that the integration of a structural unit in reflectors and luminaires having a very short physical length is possible. The shortening in comparison with the prior art takes place in such a way that the connection between the electrode system, in particular the external power supply line, any frame which may be present of a lamp can lie outside the outer bulb. As a result, improved conduction of heat is achieved at the fuse seal of the electrode system in the ceramic capillary, especially since an extension of the capillaries as a result of the length saved and therefore additional heat dissipation is possible.

The production of the sealing face of the outer bulb directly at the ceramic capillaries, either as a result of direct fusing of the end of the outer bulb or as a result of the use of a further, possibly even multilayered glass solder with a gradient of the coefficient of thermal expansion, obviates the need for the use of Mo foils which has until now been necessary in the glass pinch-sealing region of the outer bulb. In addition, the individual components comprising the outer bulb and the discharge vessel can be manufactured prior to the discharge vessel being filled with metal halides, mercury and electrode systems, with the result that no thermal influencing of the discharge vessel system and the fuse seal takes place as a result of subsequent manufacturing process steps.

As an alternative to a sealed-off outer bulb, the latter can be designed to be open, i.e. without being sealed off from the outer atmosphere. In this case, the outer bulb is used merely as an explosion protection means and optionally as an optical filter. A mechanical spring clip can be fitted between the outer bulb and the ceramic capillary, which spring clip at the same time as fixing the discharge vessel to the outer bulb takes on the function of a starting aid.

The direct sealing-off between the outer bulb and the ceramic discharge vessel is very difficult, however, owing to the different coefficient of thermal expansion, with the result that this embodiment can preferably be used for cases without vacuum-tight sealing of the outer bulb.

The two sealing faces at the opposite ends of the outer bulb can be produced by thermal shaping of the ends of the outer bulb. They can be produced in one working step and using one manufacturing system. Transforming processes or separate exhaust tubes are no longer required. A precondition for this is the production of the sealing faces in a process chamber, which is filled with the desired outer bulb gas. Furthermore, the symmetry allows the frame to be connected freely or allows for any desired installation positions, which can be matched depending on the operating position. It is also possible for the outer bulb to comprise two parts.

In order to avoid contact between Nb-containing constituents of the electrode system, as are normally used, and the oxygen-containing environment, other electrode constructions can be used:

a) four-part Eo system W/Mo/Nb/Mo: the Nb part of the four-part electrode system is completely enveloped by a glass solder at the edge of the ceramic capillary of the burner. The electrode system again has an Mo-containing subsection, which is largely inert with respect to the atmosphere, outside the oxygen-free region.
b) Mo wires are spun around a ceramic core and the latter is provided with a W electrode (so-called multistrand system). The electrode system again has an Mo-containing subsection, which is largely inert with respect to the atmosphere, outside the oxygen-free region.
c) cermet bushing: the electrode system consists of W/Mo/cermet, i.e. a mixture of Al₂O₃ and Mo. The electrode system has a cermet subsection, which is largely inert with respect to the atmosphere, outside the oxygen-free region.

A further advantageous geometrical feature is the large distance between the power supply line contacts and the design freedom with respect to the frame and the power supply lines. As a result, high starting voltages of markedly greater than 2 kV are possible, which in turn make possible the options of hot-restarting and rapid availability of light.

The essential features of the structural unit are the short outer bulb, which in each case terminates approximately at the level of the capillary, for the purpose of reducing the length and the possibility of using high starting voltages as a result of the large distance between the two power supply line contacts.

Overall, the novel concept makes it possible to reduce the physical length of a lamp by an order of magnitude of 10 mm, which given a typical physical length of previously 60 to 70 mm corresponds to an order of magnitude of approximately 15%.

### BRIEF DESCRIPTION OF THE DRAWINGS

The invention will be explained in more detail below with reference to a plurality of exemplary embodiments. In the figures:

FIG. 1 shows a first exemplary embodiment of a structural unit as a whole (FIG. 1a) and in detail (FIG. 1b);

FIGS. 2 to 5 show further exemplary embodiments of a structural unit;

FIG. 6 shows an exemplary embodiment of a reflector lamp; and

FIG. 7 shows a further exemplary embodiment of a reflector lamp.

### PREFERRED EMBODIMENT OF THE INVENTION

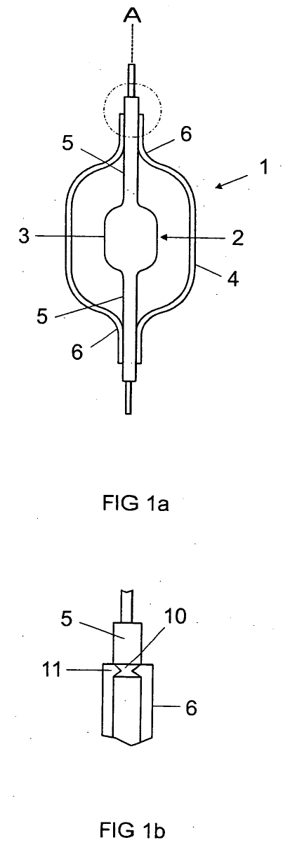

FIG. 1a shows a structural unit 1. It comprises a ceramic discharge vessel 2, which is held in an outer bulb 4 consisting of quartz glass along a longitudinal axis A. The discharge vessel 2 comprises a bulging central part 3 and two capillaries 5, which are attached thereto, as is known per se. However, the specific form of the central part is insignificant as regards the invention. The outer bulb has, in the center, a maximum diameter at the level of the discharge vessel. It has two ends 6 with a reduced diameter, which ends extend in the direction of the capillaries 5. In the specific exemplary embodiment, the end 6 of the outer bulb rests directly on the capillary. The capillary 5 has, on the outside, see the detail in FIG. 1b, a peripheral furrow 10, into which the heated end 6 of the outer bulb is molded during the shaping process by means of a latching tab 11, which is integrally formed at the end 6. A mechanical simple holding option for the outer bulb is therefore provided, an atmosphere comprising air prevailing within the outer bulb.

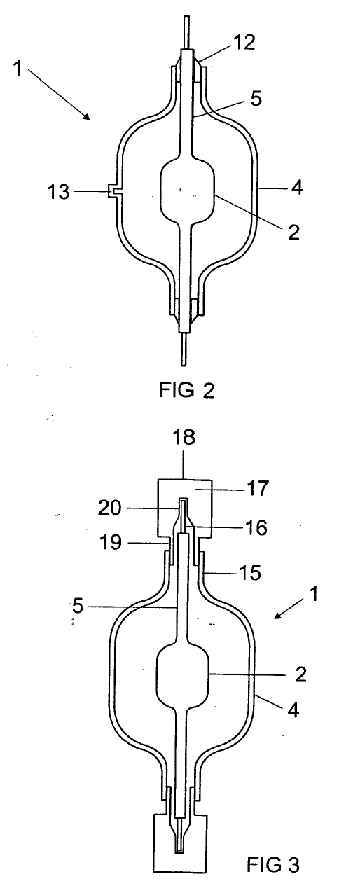

FIG. 2 shows a structural unit 1, in which the outer bulb 4 is joined in a vacuum-tight manner to the discharge vessel 2. This takes place by means of a multilayered coating 12 of glass solder, which is fitted between the end of the outer bulb and the capillary 5. In order to make it possible to evacuate and fill the outer bulb, the outer bulb has an exhaust tube 13. The multilayered coating consisting of glass solders comprises glass solders known per se, for example similar to those described in EP0652586.

FIG. 3 shows an exemplary embodiment of a structural unit 1, in which the end 15 of the outer bulb 4 is not led up directly to the capillary 5, but is only led up to its immediate vicinity. The overall length of the outer bulb can in this case even be slightly longer than that of the discharge vessel 2, or else slightly shorter. A special cup-shaped contact sleeve 17 is fitted at the end of the capillary of the discharge vessel at the external power supply line 16. This contact sleeve 17 has an enlarged bottom 18, which accommodates the external power supply line in the bore 20. The wall 19 of the cup bears from the inside against the end 6 of the outer bulb. The cup-shaped contact sleeve is preferably manufactured from molybdenum, as is known per se in principle. A vacuum-tight seal between the outer bulb and the contact sleeve can take place, for example, by means of glass solder. Other ductile materials can also be used for the contact sleeve, see in this regard, for example, U.S. Pat. No. 3,685,475.

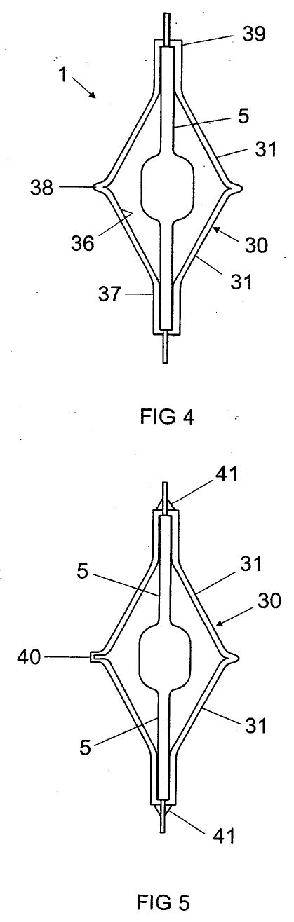

FIG. 4 shows an exemplary embodiment of a structural unit 1 similar to FIG. 1, but the outer bulb 30 comprises two funnel-shaped parts 31, each comprising a funnel opening 36 and a funnel neck 37, which have been subsequently assembled in the center 38, i.e. the opening of the funnel. In this embodiment, the neck 37 of the funnel does not need to be reduced to the diameter of the capillary 5 in a complex manner once it has been positioned on the discharge vessel. Instead, the funnel neck is already matched as well as possible to the diameter of the capillary in advance. It is only necessary for a join, for example by means of moderate local heating in the form of an edge seam 38, to be provided between the edge faces of the two funnel openings 31. It can be held on the discharge vessel, for example, by means of a latching tab 39 at the end of the funnel neck.

If vacuum-tight sealing of the outer bulb is desired, an exhaust hole 40 is provided in the region of the edge seam, see FIG. 5, and the latching tab 39 at the end of the funnel neck is joined to the end of the capillary 5 by means of glass solder 41.

The discharge vessel has, for example, a filling consisting of metal halides, as known per se. Furthermore, two electrodes are arranged in the discharge vessel, and the discharge arc burns between said electrodes.

The two parts 31 of the outer bulb are advantageously identical and can be joined to one another approximately at the level of the central part of the discharge vessel, as shown. The axial length of the two parts 31 is then approximately the same in a rough estimation. Different lengths of the two parts 31 are naturally also possible, however.

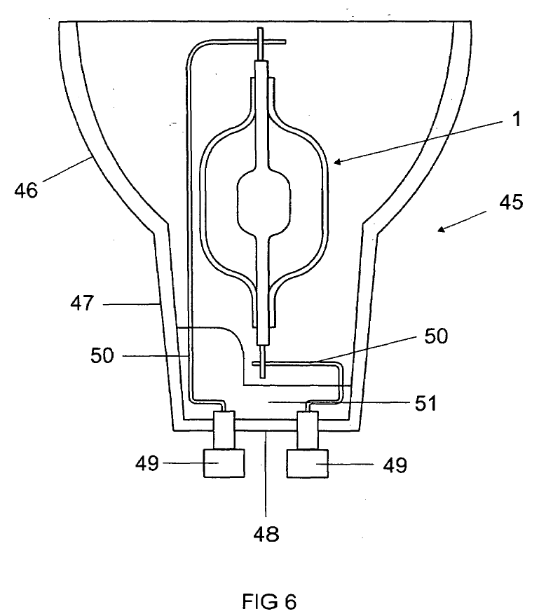

FIG. 6 shows a reflector lamp 45, which contains a structural unit as described above. It comprises a structural unit 1 with a discharge vessel and an outer bulb as described, for example, in FIG. 1. This structural unit is accommodated in a reflector as an enveloping part, the reflector having a concave front part 46 and a neck region 47, which ends in a terminating plate 48. Two contact pieces 49 are fixed in said plate. Two frame wires 50 fix the structural unit in the lamp by them being led to the two contact pins 49 in the plate at the end of the neck. In addition, the frame wires are fixed with cement 51. Other fixing options can naturally also be used.

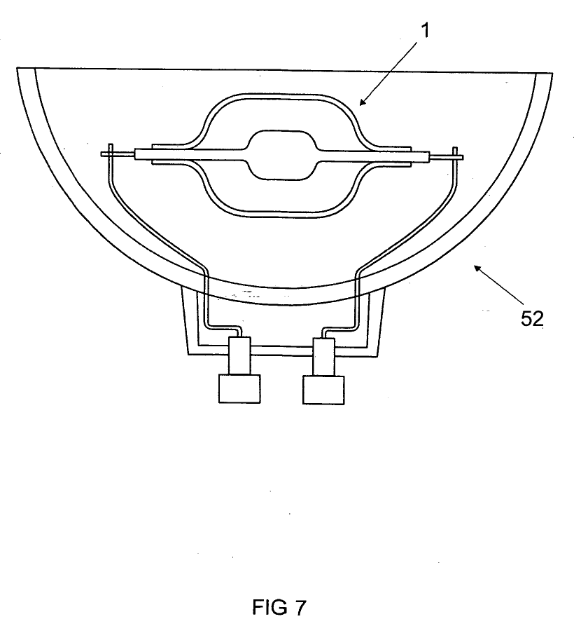

FIG. 7 shows a reflector lamp 52, in which the structural unit 1 is fitted transversely with respect to the longitudinal axis of the reflector. This fitting is easily possible as a result of the small physical length of the structural unit.

The filling in the inner bulb is a conventional filling in the case of a filament as the luminous means, as described in EP-A 295 592, for example.

The dimensions of the lamps vary depending on geometrical variant embodiments and the lamp power. The minimum lamp length in the case of a metal-halide lamp with a ceramic discharge vessel and a power of 20 W is 34 mm. Similarly, the minimum lamp length in the case of a power of 35 W is approximately 41 mm.

1. A structural unit for an electric lamp, with an elongated, ceramic inner bulb, with a central part, which is closed at two sides by capillaries, the inner bulb having a lamp axis, and a luminous means being accommodated in the inner bulb, the inner bulb being surrounded by an outer bulb, characterized in that the outer bulb has two ends, which are joined directly to the capillaries of the discharge vessel via in each case one joining means.

2. The structural unit as claimed in claim 1, characterized in that the joining means is a tab at the end of the outer bulb, which extends into a furrow, which is applied to the outside of the capillary.

3. The structural unit as claimed in claim 1, characterized in that the joining means is a glass solder, which comprises a plurality of layers and which extends between the capillary and the end of the outer bulb.

4. The structural unit as claimed in claim 1, characterized in that the joining means is a cup-shaped contact sleeve, the cup having a wall and a base, the end of the outer bulb bearing against the wall of the cup, and the base of the cup being joined to the outer power supply line, which protrudes out of the discharge vessel.

5. The structural unit as claimed in claim 1, characterized in that the outer bulb comprises two parts, each part being widened in the form of a funnel and having a funnel opening and a neck, the neck having an inwardly pointing edge at its end, which edge bears against the end of the capillary and is possibly sealed off there by means of glass solder.

6. The structural unit as claimed in claim 1, characterized in that the material of the outer bulb consists of quartz glass, hard glass or Vycor.

7. The structural unit as claimed in claim 1, characterized in that the lamp is an incandescent lamp, the luminous means being an incandescent filament.

8. The structural unit as claimed in claim 1, characterized in that the lamp is a discharge lamp, the luminous means being a discharge arc.

9. The structural unit as claimed in claim 1, characterized in that the structural unit comprising the inner bulb and the outer bulb is accommodated in an enveloping part, in particular in a reflector or in a further bulb.

10. A lamp or luminaire with a structural unit as claimed in claim 1.
